(19) United States
(12) Patent Application Publication
(10) Pub. No.: US 2020/0020067 A1
(43) Pub. Date: Jan. 16, 2020

(54) CONCURRENT BINNING AND RENDERING

(71) Applicant: QUALCOMM Incorporated, San Diego, CA (US)

(72) Inventors: Jian LIANG, San Diego, CA (US); Tao WANG, Sunnyvale, CA (US); Chun YU, Rancho Santa Fe, CA (US); Andrew Evan GRUBER, Arlington, MA (US); Donghyun KIM, San Diego, CA (US); Nigel POOLE, West Newton, MA (US); Tzun-Wei LEE, San Jose, CA (US); Shambhoo KHANDELWAL, Santa Clara, CA (US)

(21) Appl. No.: 16/035,372

(22) Filed: Jul. 13, 2018

(51) Int. Cl. G06T 1/20; G06T 15/00; G06T 1/60

(52) U.S. Cl. CPC G06T 1/20; G06T 1/60; G06T 15/005

(57) ABSTRACT

A method, an apparatus, and a computer-readable medium may be configured to perform a binning pass for a first frame. The apparatus may be configured to perform a rendering pass for the first frame in parallel with the binning pass. The apparatus may be configured to enhance efficiency in performing a binning pass and a rendering pass for tile-based rendering, such that the binning pass and rendering pass are performed concurrently. The apparatus may be configured to perform the binning pass using a first hardware pipeline, and may be configured to perform the rendering pass using a second hardware pipeline.

### BACKGROUND

Technical Filed

The present disclosure relates generally to concurrent binning and rendering.

### INTRODUCTION

Computing devices often utilize a graphics processing unit (GPU) to accelerate the rendering of graphical data for display. Such computing devices may include, for example, computer workstations, mobile phones such as so-called smartphones, embedded systems, personal computers, tablet computers, and video game consoles. GPUs execute a graphics processing pipeline that includes a plurality of processing stages that operate together to execute graphics processing commands/instructions and output a frame. A central processing unit (CPU) may control the operation of the GPU by issuing one or more graphics processing commands/instructions to the GPU. Modern day CPUs are typically capable of concurrently executing multiple applications, each of which may need to utilize the GPU during execution. A device that provides content for visual presentation on a display generally includes a graphics processing unit (GPU).

A GPU renders a frame for display. This rendered frame may be processed by a display processing unit prior to being displayed. For example, the display processing unit may be configured to perform processing on one or more frames that were rendered for display by the GPU and subsequently output the processed frame to a display. The pipeline that includes the CPU, GPU, and DPU may be referred to as a display processing pipeline.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be configured to perform a binning pass for a first frame. The apparatus may be configured to perform a rendering pass for the first frame in parallel with the binning pass.

In an aspect of the disclosure, a method, a computer-readable medium, and an apparatus are provided. The apparatus may be configured to perform a binning pass for a first frame. The apparatus may be configured to perform a rendering pass for a second frame in parallel with the binning pass.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1A is a block diagram that illustrates an example content generation and coding system in accordance with the techniques of this disclosure.

FIG. 1B is a block diagram that illustrates an example configuration between a component of the device depicted in FIG. 1A and a display.

FIG. 1C is a block diagram that illustrates an example configuration between a component of the device depicted in FIG. 1A and a display.

FIGS. 2A-2B illustrate an example flow diagram in accordance with the techniques described herein.

FIG. 3 illustrates an example flowchart of an example method in accordance with one or more techniques of this disclosure.

FIG. 4 illustrates an example flowchart of an example method in accordance with one or more techniques of this disclosure.

FIG. 5 illustrates example binning and rendering passes in accordance with one or more techniques of this disclosure.

FIG. 6 illustrates an example hardware architecture in accordance with one or more techniques of this disclosure.

### DETAILED DESCRIPTION

Various aspects of systems, apparatuses, computer program products, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of this disclosure to those skilled in the art. Based on the teachings herein one skilled in the art should appreciate that the scope of this disclosure is intended to cover any aspect of the systems, apparatuses, computer program products, and methods disclosed herein, whether implemented independently of, or combined with, other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. Any aspect disclosed herein may be embodied by one or more elements of a claim.

Although various aspects are described herein, many variations and permutations of these aspects fall within the scope of this disclosure. Although some potential benefits and advantages of aspects of this disclosure are mentioned, the scope of this disclosure is not intended to be limited to particular benefits, uses, or objectives. Rather, aspects of this disclosure are intended to be broadly applicable to different wireless technologies, system configurations, networks, and transmission protocols, some of which are illustrated by way of example in the figures and in the following description. The detailed description and drawings are merely illustrative of this disclosure rather than limiting, the scope of this disclosure being defined by the appended claims and equivalents thereof.

Several aspects are presented with reference to various apparatus and methods. These apparatus and methods are described in the following detailed description and illustrated in the accompanying drawings by various blocks, components, circuits, processes, algorithms, and the like (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors (which may also be referred to as processing units). Examples of processors include microprocessors, microcontrollers, graphics processing units (GPUs), general purpose GPUs (GPGPUs), central processing units (CPUs), application processors, digital signal processors (DSPs), reduced instruction set computing (RISC) processors, systems on a chip (SoC), baseband processors, application specific integrated circuits (ASICs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise. The term application may refer to software. As described herein, one or more techniques may refer to an application (i.e., software) being configured to perform one or more functions. In such examples, it is understood that the application may be stored on a memory (e.g., on-chip memory of a processor, system memory, or any other memory). Hardware described herein, such as a processor may be configured to execute the application. For example, the application may be described as including code that, when executed by the hardware, causes the hardware to perform one or more techniques described herein. As an example, the hardware may access the code from a memory and execute the code accessed from the memory to perform one or more techniques described herein. In some examples, components are identified in this disclosure. In such examples, the components may be hardware, software, or a combination thereof. The components may be separate components or sub-components of a single component.

Accordingly, in one or more examples described herein, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

As used herein, instances of the term “content” may refer to graphical content or display content. In some examples, as used herein, the term “graphical content” may refer to a content generated by a processing unit configured to perform graphics processing. For example, the term “graphical content” may refer to a content generated by one or more processes of a graphics processing pipeline. In some examples, as used herein, the term “graphical content” may refer to a content generated by a graphics processing unit. In some examples, as used herein, the term “display content” may refer to content generated by a processing unit configured to perform displaying processing. In some examples, as used herein, the term “display content” may refer to a content generated by a display processing unit. Graphical content may be processed to become display content. For example, a graphics processing unit may output graphical content, such as a frame, to a buffer. A display processing unit may read the graphical content, such as one or more frames from the buffer, and perform one or more display processing techniques thereon to generate display content. For example, a display processing unit may be configured to perform composition on one or more rendered layers to generate a frame. As another example, a display processing unit may be configured to compose, blend, or otherwise combine two or more layers together into a single frame. A display processing unit may be configured to perform scaling (e.g., upscaling or downscaling) on a frame. In some examples, a frame may refer to a layer. In other examples, a frame may refer to two or more layers that have already been blended together to form the frame (i.e., the frame includes two or more layers, and the frame that includes two or more layers may subsequently be blended).

As referenced herein, a first component (e.g., a GPU) may provide content, such as a frame, to a second component (e.g., a DPU). In some examples, the first component may provide content to the second component by storing the content in a memory accessible to the second component. In such examples, the second component may be configured to read the content stored in the memory by the first component. In other examples, the first component may provide content to the second component without any intermediary components (e.g., without memory or another component). In such examples, the first component may be described as providing content directly to the second component. For example, the first component may output the content to the second component, and the second component may be configured to store the content received from the first component in a memory, such as a buffer.

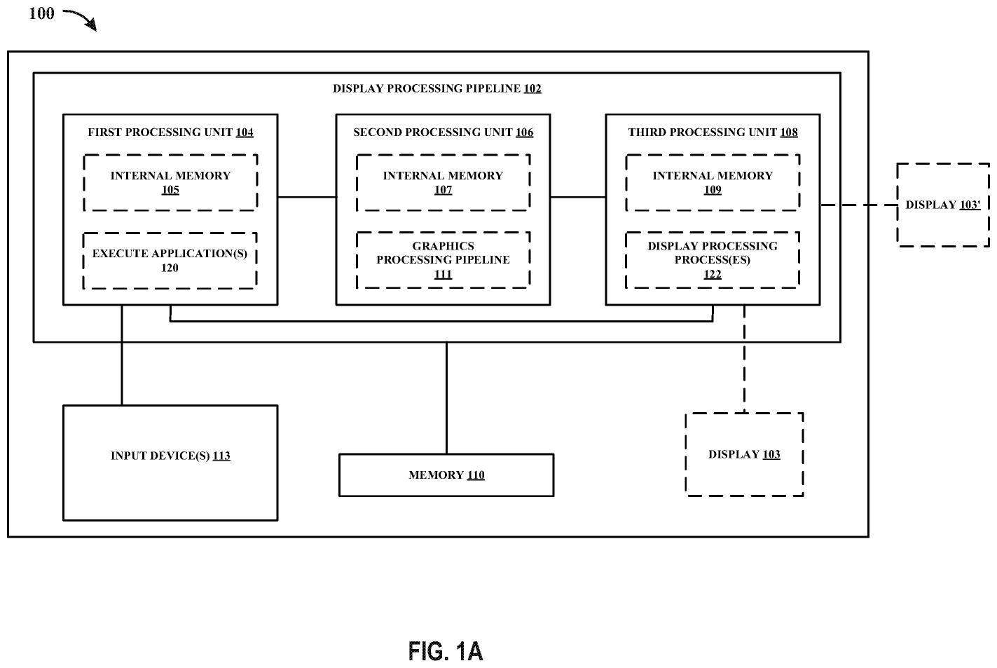

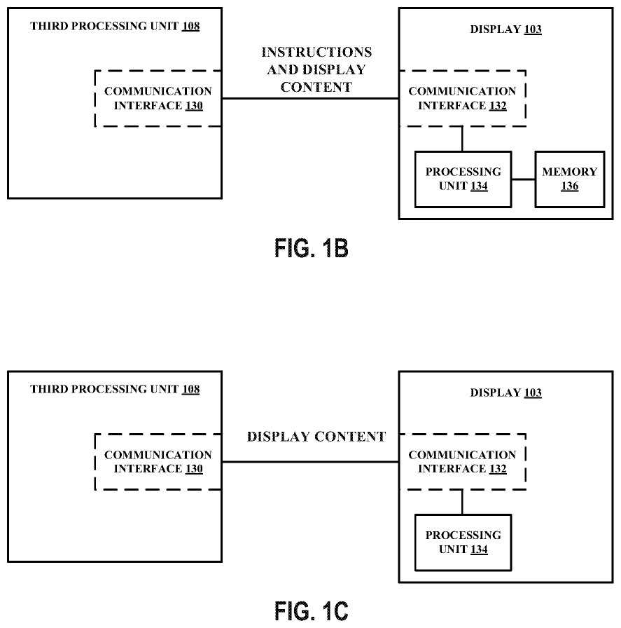

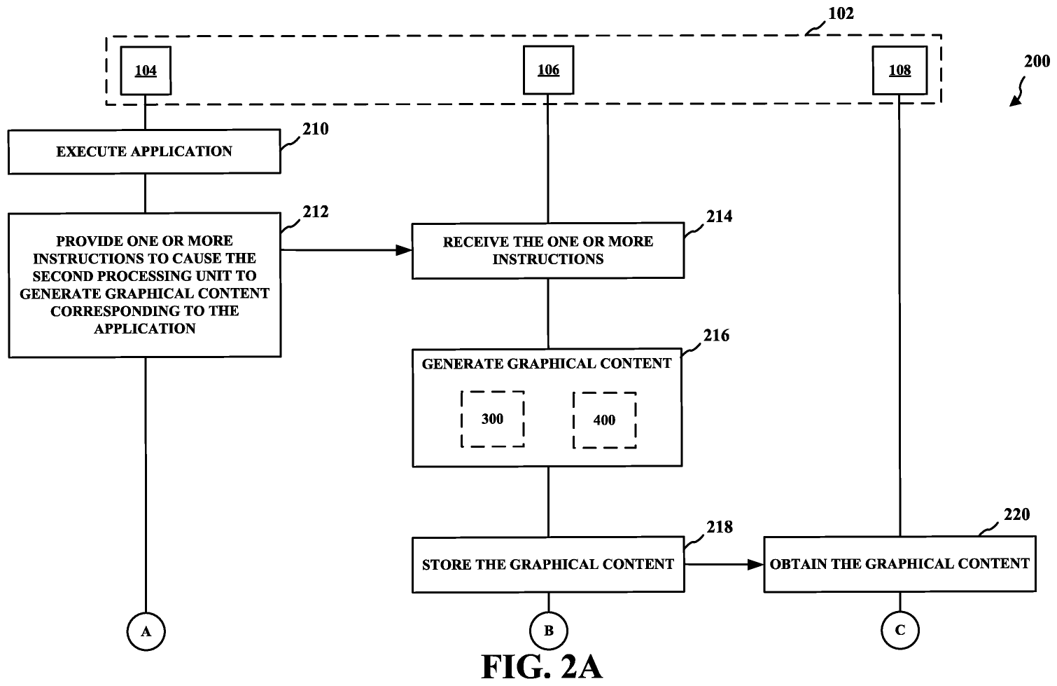

FIG. 1A is a block diagram that illustrates an example device 100 configured to perform one or more techniques of this disclosure. The device 100 includes display processing pipeline 102 configured to perform one or more technique of this disclosure. In accordance with the techniques described herein, the display processing pipeline 102 may be configured to generate content destined for display. The display processing pipeline 102 may be communicatively coupled to a display 103. In the example of FIG. 1A, the display 103 is a display of the device 100. However, in other examples, the display 103 may be a display external to the device 100 (as shown in FIG. 1 with display 103′). Reference to display 103 may refer to display 103 or display 103′ (i.e., a display of the device or a display external to the device).

In examples where the display 103 is not external to the device 100, the a component of the device may be configured to transmit or otherwise provide commands and/or content to the display 103 for presentment thereon. In examples where the display 103 is external to the device 100, the device 100 may be configured to transmit or otherwise provide commands and/or content to the display 103 for presentment thereon. As used herein, “commands,” “instructions,” and “code” may be used interchangeably. In some examples, the display 103 of the device 100 may represent a display projector configured to project content, such as onto a viewing medium (e.g., a screen, a wall, or any other viewing medium). In some examples, the display 103 may include one or more of: a liquid crystal display (LCD), a plasma display, an organic light emitting diode (OLED) display, a projection display device, an augmented reality (AR) display device, a virtual reality (VR) display device, a head-mounted display, a wearable display, or any other type of display.

The display processing pipeline 102 may include one or more components (or circuits) configured to perform one or more techniques of this disclosure. As used herein, reference to the display processing pipeline being configured to perform any function, technique, or the like refers to one or more components of the display processing pipeline being configured to form such function, technique, or the like.

In the example of FIG. 1A, the display processing pipeline 102 includes a first processing unit 104, a second processing unit 106, and a third processing unit 108. In some examples, the first processing unit 104 may be configured to execute one or more applications 120, the second processing unit 106 may be configured to perform graphics processing, and the third processing unit 108 may be configured to perform display processing. In such examples, the first processing unit 104 may be a central processing unit (CPU), the second processing unit 106 may be a graphics processing unit (GPU) or a general purpose GPU (GPGPU), and the third processing unit 108 may be a display processing unit (DPU), which may also be referred to as a display processor. In other examples, the first processing unit 104, the second processing unit 106, and the third processing unit 108 may each be any processing unit configured to perform one or more feature described with respect to each processing unit.

The first processing unit may include an internal memory 105. The second processing unit 106 may include an internal memory 107. In some examples, the internal memory 107 may be referred to as a GMEM. The third processing unit 108 may include an internal memory 109. One or more of the processing units 104, 106, and 108 of the display processing pipeline 102 may be communicatively coupled to a memory 110. The memory 110 may be external to the one or more of the processing units 104, 106, and 108 of the display processing pipeline 102. For example, the memory 110 may be a system memory. The system memory may be a system memory of the device 100 that is accessible by one or more components of the device 100. For example, the first processing unit 104 may be configured to read from and/or write to the memory 110. The second processing unit 106 may be configured to read from and/or write to the memory 110. The third processing unit 108 may be configured to read from and/or write to the memory 110. The first processing unit 104, the second processing unit 106, and the third processing unit 108 may be communicatively coupled to the memory 110 over a bus. In some examples, the one or more components of the display processing pipeline 102 may be communicatively coupled to each other over the bus or a different connection. In other examples, the system memory may be a memory external to the device 100.

The internal memory 105, the internal memory 107, the internal memory 109, and/or the memory 110 may include one or more volatile or non-volatile memories or storage devices. In some examples, the internal memory 105, the internal memory 107, the internal memory 109, and/or the memory 110 may include random access memory (RAM), static RAM (SRAM), dynamic RAM (DRAM), erasable programmable ROM (EPROM), electrically erasable programmable ROM (EEPROM), Flash memory, a magnetic data media or an optical storage media, or any other type of memory.

The internal memory 105, the internal memory 107, the internal memory 109, and/or the memory 110 may be a non-transitory storage medium according to some examples. The term “non-transitory” may indicate that the storage medium is not embodied in a carrier wave or a propagated signal. However, the term “non-transitory” should not be interpreted to mean that the internal memory 105, the internal memory 107, the internal memory 109, and/or the memory 110 is non-movable or that its contents are static. As one example, the memory 110 may be removed from the device 100 and moved to another device. As another example, the memory 110 may not be removable from the device 100.

In some examples, the first processing unit 104 may be configured to perform any technique described herein with respect to the second processing unit 106. In such examples, the display processing pipeline 102 may only include the first processing unit 104 and the third processing unit 108. Alternatively, the display processing pipeline 102 may still include the second processing unit 106, but one or more of the techniques described herein with respect to the second processing unit 106 may instead be performed by the first processing unit 104.

In some examples, the first processing unit 104 may be configured to perform any technique described herein with respect to the third processing unit 108. In such examples, the display processing pipeline 102 may only include the first processing unit 104 and the second processing unit 106. Alternatively, the display processing pipeline 102 may still include the third processing unit 108, but one or more of the techniques described herein with respect to the third processing unit 108 may instead be performed by the first processing unit 104.

In some examples, the second processing unit 106 may be configured to perform any technique described herein with respect to the third processing unit 108. In such examples, the display processing pipeline 102 may only include the first processing unit 104 and the second processing unit 106. Alternatively, the display processing pipeline 102 may still include the third processing unit 108, but one or more of the techniques described herein with respect to the third processing unit 108 may instead be performed by the second processing unit 106.

The first processing unit 104 may be configured to execute one or more applications 120. The first processing unit 104 may be configured to provide one or more commands/instructions (e.g., draw instructions) to the second processing unit 106 to cause the second processing unit 106 to generate graphical content. As used herein, “commands,” “instructions,” and “code” may be used interchangeably. For example, execution of an application of the one or more applications 120 may cause one or more commands/instructions (e.g., draw instructions) corresponding to the application to be provided to the second processing unit 106 to generate graphical content for the application. In some examples, an application may be software (e.g., code) stored in the internal memory 105. In other examples, an application may be software stored in the memory 110 or another memory accessible to the first processing unit 104. In other examples, an application may be software stored in a plurality of memories, such as the internal memory 105 and the memory 110.

The second processing unit 106 may be configured to perform graphics processing in accordance with the techniques described herein, such as in a graphics processing pipeline 111. Otherwise described, the second processing unit 106 may be configured to perform any process described herein with respect to the second processing unit 106. For example, the second processing unit 106 may be configured to generate graphical content using tile-based rendering (also referring to as “binning”), direct rendering, adaptive rendering, foveated rendering, spatial anti-alias rendering, and/or any graphics processing technique.

In tile-based rendering, the second processing unit 106 may be configured to divide a buffer (e.g., a framebuffer) into a plurality of sub-regions referred to as bins or tiles. For example, if the internal memory 107 is able to store N memory units of data (where N is a positive integer), then a scene may be divided into bins such that the pixel data contained in each bins is less than or equal to N memory units. In this way, the second processing unit 106 may render the scene by dividing the scene into bins that can be individually rendered into the internal memory 107, store each rendered bin from internal memory 107 to a framebuffer (which may be located in the memory 110), and repeat the rendering and storing for each bin of the scene. It is understood that a rendered frame is the combination of all the rendered bins. Rendering a bin into the internal memory 107 may include executing commands to render the primitives in the associated bin into the internal memory 107. The buffer that stores the rendered frame (i.e., all rendered bins corresponding to the frame) is referred to as the framebuffer. The framebuffer is allocated memory that holds one or more rendered frames that can be read by one or more other components, such as the third processing unit 108. Therefore, reference to dividing a framebuffer into a plurality of sub-regions refers to configuring the second processing unit 106 to render graphical content corresponding to a frame on a bin-by-bin basis.

As used herein, a “surface” may be interchangeable with “frame,” “sub-frame,” layer, or the like. For example, as described herein, the second processing unit 106 may be configured to render one or more surfaces of a frame. The second processing unit 106 may be configured to store each rendered surface for the frame into a respective intermediate buffer. The second processing unit 106 may be configured to combine (e.g., blend) the one or more rendered surfaces together to generate the frame. The second processing unit 106 may be configured to store the frame in the framebuffer. In this way, each surface may also be referred to as a frame or sub-frame. For example, the second processing unit 106 may be configured to generate one or more frames for generation of a final frame. The second processing unit 106 may be configured to store each rendered frame for the final frame into a respective intermediate buffer. The second processing unit 106 may be configured to combine (e.g., blend) the one or more rendered frames together to generate the final frame. The second processing unit 106 may be configured to store the final rendered frame in the framebuffer. As another example, the second processing unit 106 may be configured to generate one or more layers for generation of a final frame. The second processing unit 106 may be configured to store each rendered layer for the final frame into a respective intermediate buffer. The second processing unit 106 may be configured to combine (e.g., blend) the one or more rendered layers together to generate the final frame. The second processing unit 106 may be configured to store the final rendered frame in the framebuffer.

As described herein, the bins defined during the binning pass may be synonyms for bins/tiles of a rendered surface (which may be referred to as the rendered scene). For example, each bin may represent a portion of the rendered surface. The bins making up a scene can each be associated with a bin in memory that stores the graphical content included in each respective bin. A bin may be a portion of a memory that stores a portion of a rendered surface.

Tile-based rendering generally includes two passes: a binning pass and a rendering pass. During the binning pass, the second processing unit 106 may be configured to receive and process draw commands for a particular scene in preparation for rendering the scene into a frame. A draw command may include one or more primitives. A primitive may have one or more vertices. The second processing unit 106 may be configured to generate position data (e.g., coordinate data, such as three-axis (X, Y, Z) coordinate data) in screen space for each vertex of each primitive in the draw commands for a particular scene. During the binning pass, the second processing unit 106 may be configured to divide a buffer into which a frame is to be rendered into a plurality bins. In some examples, the second processing unit 106 may be configured to generate visibility information for each bin of the plurality of bins during the binning pass. In this regard, it is understood that the second processing unit 106 may be configured to generate visibility information on a per bin basis (e.g., visibility information is generated for each bin).

After generating visibility information for each bin (e.g., during the binning pass), the second processing unit 106 may be configured to separately render each respective bin of the plurality of bins using the respective visibility information for each respective bin. In some examples, the second processing unit 106 may be configured to use the visibility stream generated during the binning pass to refrain from rendering primitives identified as invisible during the binning pass, which avoids overdraw. Accordingly, only the visible primitives and/or the possibly visible primitives are rendered into each bin.

During the rendering of each bin, the second processing unit 106 may be configured to store the pixel values corresponding to the bin being rendered in the internal memory 107. In this way, tile-based rendering uses the internal memory 107 of the second processing unit 106. The second processing unit 106 may be configured to store (e.g., copy) a rendered bin stored in the internal memory 107 to a memory external to the second processing unit 106, such as memory 110. In some examples, once a bin is fully rendered into the internal memory 107, the second processing unit 106 may be configured to store the fully rendered bin to a memory external to the second processing unit 106. In other examples, the second processing unit 106 may be configured to render graphical content for a bin into the internal memory 107 and store graphical content rendered into the internal memory 107 into a memory external to the second processing unit 106 in parallel. Accordingly, while the second processing unit 106 can render graphical content on a bin-by-bin basis, rendering graphical content on a bin-by-bin basis into the internal memory 107 and subsequently storing the rendered graphical content corresponding to each bin from the internal memory 107 to the framebuffer (e.g., allocated in the memory 110) may result in inefficient graphics processing (e.g., inefficient consumption of processing resources of the second processing unit 106).

As used herein, “visibility information” may, in some examples, refer to any information in any data structure that indicates whether one or more primitives is visible and/or may be visible (e.g., possibly visible) with respect to the bin for which the visibility information was generated. Whether a primitive is visible/possibly visible or not visible may, as described herein, respectively refer to whether the primitive will be rendered or not rendered with respect to the bin for which the visibility information was generated. As used herein, a primitive that “may be visible” (e.g., a possibly visible primitive) may refer to the fact that it is unknown whether the primitive will be visible or will not be visible in the rendered frame (i.e., in the respective rendered bin of the rendered frame) at a particular processing point in the graphics processing pipeline (e.g., during the binning pass before the rendering pass) according to one examples. In another example, a primitive that “may be visible” (e.g., a possibly visible primitive) may refer to a primitive that is not or will not be definitively visible in the rendered frame (i.e., in the respective rendered bin of the rendered frame) at a particular processing point in the graphics processing pipeline (e.g., during the binning pass before the rendering pass).

For example, “visibility information” may refer to any information in any data structure that indicates whether one or more primitives associated with one or more draw commands is visible and/or may be visible with respect to the bin. As another example, “visibility information” may be described as a visibility stream that includes a sequence of l's and 0's with each “1” or “0” being associated with a particular primitive located within the bin. In some examples, each “1” may indicate that the primitive respectively associated therewith is or may be visible in the rendered frame (i.e., in the respective rendered bin of the rendered frame), and each “0” may indicate that the primitive respectively associated therewith will not be visible in the rendered frame (i.e., in the respective rendered bin of the rendered frame). In other examples, each “0” may indicate that the primitive respectively associated therewith is or may be visible in the rendered frame (i.e., in respective the rendered bin of the rendered frame), and each “1” may indicate that the primitive respectively associated therewith will not be visible in the rendered frame (i.e., in the respective rendered bin of the rendered frame). In other examples, “visibility information” may refer to a data structure comprising visibility information in a format different from a visibility stream.

In direct rendering, the second processing unit 106 may be configured to render directly to the framebuffer (e.g., a memory location in memory 110) in one pass. Otherwise described, the second processing unit 106 may be configured to render graphical content to the framebuffer without using the internal memory 107 for intermediate storage of rendered graphical content. In some examples, direct rendering mode may be considered as a single bin in accordance with how tile-based rendering is performed, except that the entire framebuffer is treated as a single bin. As referred to herein, a rendering mode (e.g., a direct rendering mode, a tile-based rendering mode, an adaptive rendering mode, a foveated rendering mode, and a spatial anti-alias rendering mode) may refer to the second processing unit 106 being configured to perform one or more techniques associated with the rendering mode.

In adaptive rendering, the second processing unit 106 may be configured to combine one or more techniques of tile-based rendering and one or more techniques of direct rendering. For example, in adaptive rendering, one or more bins may be rendered to the internal memory 107 and subsequently stored from the internal memory 107 to the framebuffer in a memory external to the second processing unit 106 (e.g., the bins that are rendered using tile-based rendering mode), and one or more bins may be rendered directly to the framebuffer in the memory external to the second processing unit 106 (e.g., the bins that are rendered using direct rendering mode). The second processing unit 106 may be configured to render bins that are to be rendered using direct rendering using the visibility information generated during the binning pass for these respective bins and the rendering of these direct rendered bins may occur in one rendering pass. Conversely, the second processing unit 106 may be configured to render bins that are to be rendered using tile-based rendering using the visibility information generated during the binning pass for these respective bins and the rendering of these tile-based rendered bins may occur in multiple rendering passes (e.g., a respective rendering pass for each respective bin of the bins that are rendered using tile-based rendering).

In some examples, rendering graphical content to a framebuffer may refer to writing pixel values to the framebuffer. A pixel value may have one or more components, such as one or more color components. Each component may have a corresponding value. For example, a pixel in the red, green, and blue color space may have a red color component value, a greed color component value, and a blue color component value.

The third processing unit 108 may be configured to perform one or more display processing processes 122 in accordance with the techniques described herein. For example, the third processing unit 108 may be configured to perform one or more display processing techniques on one or more frames generated by the second processing unit 106 before presentment by the display 103. Otherwise described, the third processing unit 108 may be configured to perform display processing. In some examples, the one or more display processing processes 122 may include one or more of a rotation operation, a blending operation, a scaling operating, any display processing process/operation, or any process/operation described herein with respect to the third processing unit 108.

In some examples, the one or more display processing processes 122 include any process/operation described herein with respect to the third processing unit 108. The display 103 may be configured to display content that was generated using the display processing pipeline 102. For example, the second processing unit 106 may generate graphical content based on commands/instructions received from the first processing unit 104. The graphical content may include one or more layers. Each of these layers may constitute a frame of graphical content. The third processing unit 108 may be configured to perform composition on graphical content rendered by the second processing unit 106 to generate display content. Display content my constitute a frame for display. The frame for display may include two or more layers/frames that were blended together by the third processing unit 108.

The device 100 may include or be connected to one or more input devices 113. In some examples, the one or more input devices 113 may include one or more of: a touch screen, a mouse, a peripheral device, an audio input device (e.g., a microphone or any other visual input device), a visual input device (e.g., a camera, an eye tracker, or any other visual input device), any user input device, or any input device configured to receive an input from a user. In some examples, the display 103 may be a touch screen display; and, in such examples, the display 103 constitutes an example input device 113.

The display processing pipeline 102 may be configured to execute one or more applications. For example, the first processing unit 104 may be configured to execute one or more applications. The first processing unit 104 may be configured to cause the second processing unit 106 to generate content for the one or more applications 120 being executed by the first processing unit 104. Otherwise described, execution of the one or more applications 120 by the first processing unit 104 may cause the generation of graphical content by a graphics processing pipeline 111. For example, the first processing unit 104 may issue or otherwise provide instructions (e.g., draw instructions) to the second processing unit 106 that cause the second processing unit 106 to generate graphical content based on the instructions received from the first processing unit 104. The second processing unit 106 may be configured to generate one or more layers for each application of the one or more applications 120 executed by the first processing unit 104. Each layer generated by the second processing unit 106 may be stored in a buffer. Otherwise described, the buffer may be configured to store one or more layers of graphical content rendered by the second processing unit 106. The buffer may reside in the internal memory 107 of the second processing unit 106 and/or the external memory 110 (which may be system memory of the device 100 in some examples). Each layer produced by the second processing unit 106 may constitute graphical content. The one or more layers may correspond to a single application or a plurality of applications. The second processing unit 106 may be configured to generate multiple layers of content, meaning that the first processing unit 104 may be configured to cause the second processing unit 106 to generate multiple layers of content.

FIG. 1B is a block diagram that illustrates an example configuration between the third processing unit 108 of the device and the display 103. The example of display 103 in FIG. 1B is an example of a smart panel or a command mode panel. The third processing unit 108 and the display 103 may be configured to communicate with each other over a communication medium (e.g., a wired and/or wireless communication medium). For example, the third processing unit 108 may include a communication interface 130 (e.g., a bus interface) and the display 103 may include a communication interface 132 (e.g., a bus interface) that enables communication between each other. In some examples, the communication between the third processing unit 108 and the display 103 may be compliant with a communication standard, communication protocol, or the like. For example, the communication between the third processing unit 108 and the display 103 may be compliant with the Display Serial Interface (DSI) standard. In some examples, the third processing unit 108 may be configured to provide data (e.g., display content) to the display 103 for presentment thereon. The third processing unit 108 may also be configured to provide commands/instructions to the display 103, such as when the display 103 is a command mode display. The display 103 may include a processing unit 134 and a memory 136 accessible by the processing unit 134. The processing unit 134 may be referred to as a display controller. The memory 136 may be configured to store data that the display 103 receives from the third processing unit 108. For example, the memory 136 may be configured to store (e.g., buffer) frames received from the third processing unit 108. The processing unit 134 may be configured to read data stored in the memory 136 that was received from the third processing unit 108 and drive the display 103 based on one or more commands received from the third processing unit 108.

FIG. 1C is a block diagram that illustrates an example configuration between the third processing unit 108 of the device and the display 103. The example of display 103 in FIG. 1C is an example of a dumb panel or a video mode panel. The third processing unit 108 and the display 103 may be configured to communicate with each other over a communication medium (e.g., a wired and/or wireless communication medium). For example, the third processing unit 108 may include a communication interface 130 (e.g., a bus interface) and the display 103 may include a communication interface 132 (e.g., a bus interface) that enables communication between each other. In some examples, the communication between the third processing unit 108 and the display 103 may be compliant with a communication standard, communication protocol, or the like. For example, the communication between the third processing unit 108 and the display 103 may be compliant with the Display Serial Interface (DSI) standard. In some examples, the third processing unit 108 may be configured to provide data (e.g., display content) to the display 103 for presentment thereon. The display 103 may include a processing unit 134 and may not include a memory. The processing unit 134 may be referred to as a display driver. The processing unit 134 may be configured to cause the display content received from the third processing unit 108 to be displayed on the display 103.

In some examples, one or more components of the device 100 and/or display processing pipeline 102 may be combined into a single component. For example, one or more components of the display processing pipeline 102 may be one or more components of a system on chip (SoC), in which case the display processing pipeline 102 may still include the first processing unit 104, the second processing unit 106, and the third processing unit 108; but as components of the SoC instead of physically separate components. In other examples, one or more components of the display processing pipeline 102 may be physically separate components that are not integrated into a single component. For example, the first processing unit 104, the second processing unit 106, and the third processing unit 108 may each be a physically separate component from each other. It is appreciated that a display processing pipeline may have different configurations. As such, the techniques described herein may improve any display processing pipeline and/or display, not just the specific examples described herein.

In some examples, one or more components of the display processing pipeline 102 may be integrated into a motherboard of the device 100. In some examples, one or more components of the display processing pipeline 102 may be may be present on a graphics card of the device 100, such as a graphics card that is installed in a port in a motherboard of the device 100 or a graphics card incorporated within a peripheral device configured to interoperate with the device 100.

The first processing unit 104, the second processing unit 106, and/or the third processing unit 108 may include one or more processors, such as one or more microprocessors, application specific integrated circuits (ASICs), field programmable gate arrays (FPGAs), arithmetic logic units (ALUs), digital signal processors (DSPs), discrete logic, software, hardware, firmware, other equivalent integrated or discrete logic circuitry, or any combinations thereof. In examples where the techniques described herein are implemented partially in software, the software (instructions, code, or the like) may be stored in a suitable, non-transitory computer-readable storage medium accessible by the processing unit. The processing unit may execute the software in hardware using one or more processors to perform the techniques of this disclosure. For example, one or more components of the display processing pipeline 102 may be configured to execute software. The software executable by the first processing unit 104 may be stored in the internal memory 105 and/or the memory 110. The software executable by the second processing unit 106 may be stored in the internal memory 107 and/or the memory 110. The software executable by the third processing unit 108 may be stored in the internal memory 109 and/or the memory 110.

As described herein, a device, such as the device 100, may refer to any device, apparatus, or system configured to perform one or more techniques described herein. For example, a device may be a server, a base station, user equipment, a client device, a station, an access point, a computer (e.g., a personal computer, a desktop computer, a laptop computer, a tablet computer, a computer workstation, or a mainframe computer), an end product, an apparatus, a phone, a smart phone, a server, a video game platform or console, a handheld device (e.g., a portable video game device or a personal digital assistant (PDA)), a wearable computing device (e.g., a smart watch, an augmented reality (AR) device, or a virtual reality (VR) device), a non-wearable device (e.g., a non-wearable AR device or a non-wearable VR device), any AR device, any VR device, a display (e.g., display device), a television, a television set-top box, an intermediate network device, a digital media player, a video streaming device, a content streaming device, an in-car computer, any mobile device, any device configured to generate content, or any device configured to perform one or more techniques described herein. In some examples, the device 100 may be an apparatus. The apparatus may be a processing unit, an SOC, or any device.

As described herein, devices, components, or the like may be described herein as being configured to communicate with each other. For example, one or more components of the display processing pipeline 102 may be configured to communicate with one or more other components of the device 100, such as the display 103, the memory 110, and/or one or more other components of the device 100 (e.g., one or more input devices). One or more components of the display processing pipeline 102 may be configured to communicate with each other. For example, the first processing unit 104 may be communicatively coupled to the second processing unit 106 and/or the third processing unit 108. As another example, the second processing unit 106 may be communicatively coupled to the first processing unit 104 and/or the third processing unit 108. As another example, the third processing unit 108 may be communicatively coupled to the first processing unit 104 and/or the second processing unit 106.

As described herein, communication may include the communicating of information from a first component to a second component (or from a first device to a second device). The information may, in some examples, be carried in one or more messages. As an example, a first component in communication with a second component may be described as being communicatively coupled to or otherwise with the second component. For example, the first processing unit 104 and the second processing unit 106 may be communicatively coupled. In such an example, the first processing unit 104 may communicate information to the second processing unit 106 and/or receive information from the second processing unit 106.

In some examples, the term “communicatively coupled” may refer to a communication connection, which may be direct or indirect. A communication connection may be wired and/or wireless. A wired connection may refer to a conductive path, a trace, or a physical medium (excluding wireless physical mediums) over which information may travel. A conductive path may refer to any conductor of any length, such as a conductive pad, a conductive via, a conductive plane, a conductive trace, or any conductive medium. A direct communication connection may refer to a connection in which no intermediary component resides between the two communicatively coupled components. An indirect communication connection may refer to a connection in which at least one intermediary component resides between the two communicatively coupled components. In some examples, a communication connection may enable the communication of information (e.g., the output of information, the transmission of information, the reception of information, or the like). In some examples, the term “communicatively coupled” may refer to a temporary, intermittent, or permanent communication connection.

Any device or component described herein may be configured to operate in accordance with one or more communication protocols. For example, a first and second component may be communicatively coupled over a connection. The connection may be compliant or otherwise be in accordance with a communication protocol. As used herein, the term “communication protocol” may refer to any communication protocol, such as a communication protocol compliant with a communication standard or the like. As an example, a communication protocol may include the Display Serial Interface (DSI) protocol. DSI may enable communication between the third processing unit 108 and the display 103 over a connection, such as a bus.

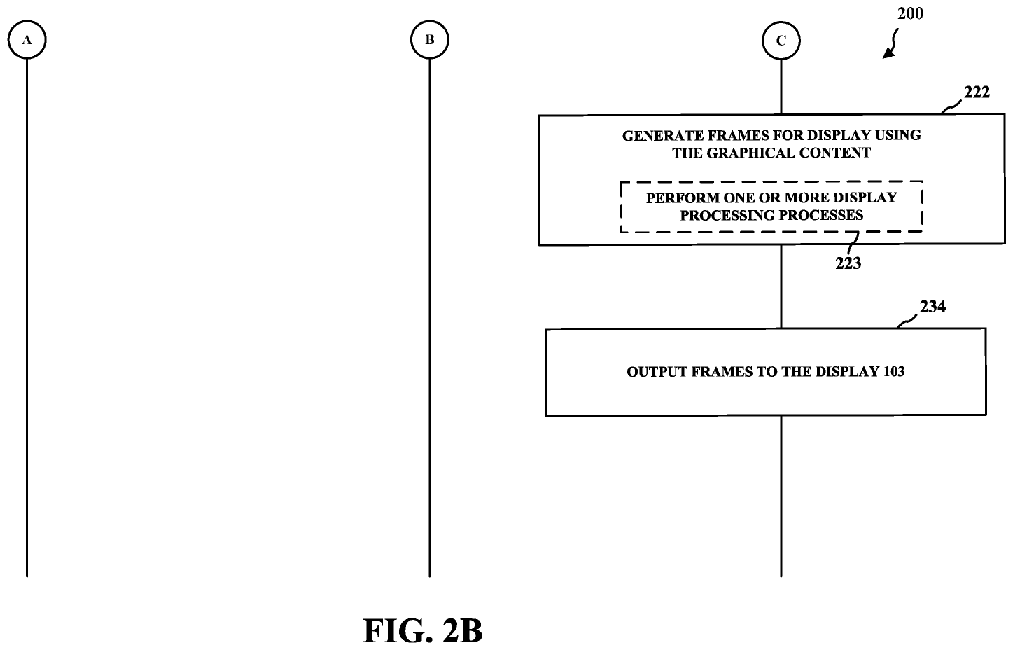

FIGS. 2A-B illustrate an example flow diagram 200 in accordance with the techniques described herein. In other examples, one or more techniques described herein may be added to the flow diagram 200 and/or one or more techniques depicted in the flow diagram may be removed. One or more blocks shown in FIGS. 2A-B may be performed in parallel.

In the example of FIGS. 2A-B, at block 210, the first processing unit 104 may be configured to execute an application. At block 212, the first processing unit 104 may be configured to provide one or more instructions to the second processing unit 106 to cause the second processing unit 106 to generate graphical content corresponding to the application. At block 214, the second processing unit 106 may be configured to receive the one or more instructions.

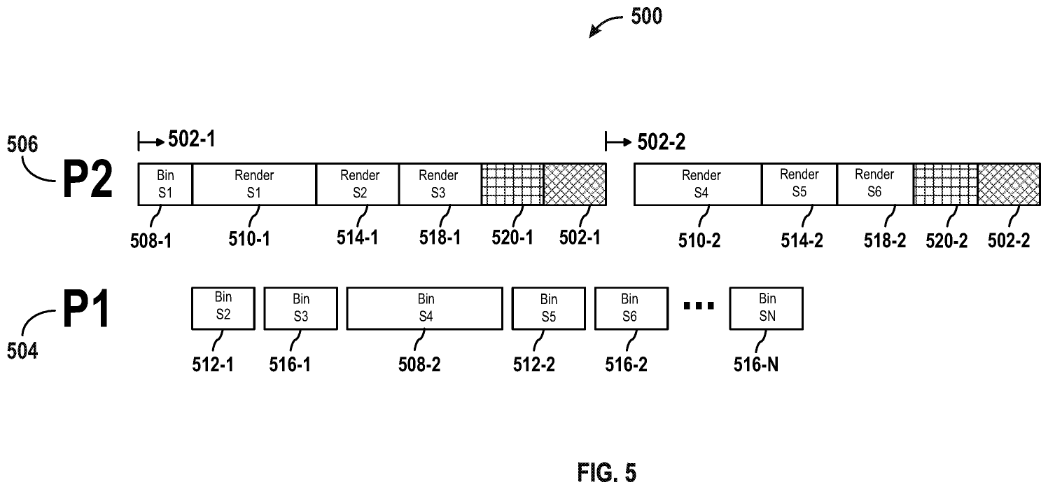

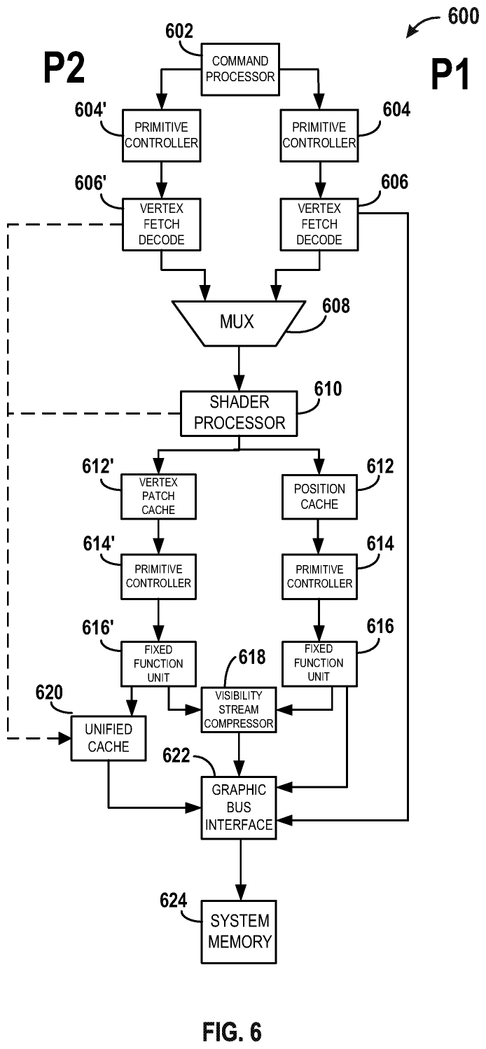

At block 216, the second processing unit 106 may be configured to generate the graphical content based on the one or more instructions received from the first processing unit 104. For example, the second processing unit 106 may be configured to generate the graphical content at block 216 in accordance with one or more techniques described herein, such as in accordance with the example flowchart 300 and/or the example flowchart 400. As another example, the second processing unit 106 may be configured to generate the graphical content at block 216 in accordance with one or more techniques described herein with respect to FIGS. 5 and 6. The graphical content may include one or more frames. A frame may include one or more surfaces.

At block 218, the second processing unit 106 may be configured store the generated graphical content (e.g., in the internal memory 107 and/or the memory 110) as described herein. Therefore, block 218 generally represents that rendered graphical content may be stored in one or more memories during rendering. For example, the second processing unit 106 may be configured to use the internal memory 107 and/or the memory 110 to store rendered graphical content. To the extent the internal memory 107 is used to store rendered graphical content, the second processing unit 106 may be configured store the rendered graphical content from the internal memory 107 to the memory 110. The location in the memory 110 at which the rendered graphical content is stored may be referred to as a framebuffer.

At block 220, the third processing unit 108 may be configured to obtain the generated graphical content from a framebuffer. For example, the third processing unit 108 may be configured to obtain one or more frames of generated graphical content from the memory 110. At block 222, the third processing unit 108 may be configured to generate frames for display using the generated graphical content obtained from the framebuffer. To generate display content, the third processing unit 108 may be configured to perform one or more display processing processes 223 (e.g., composition display processes, such as blending, rotation, or any other composition display process) on the generated graphical content read from the framebuffer. At block 234, the third processing unit 108 may be configured to output display content to the display 103.

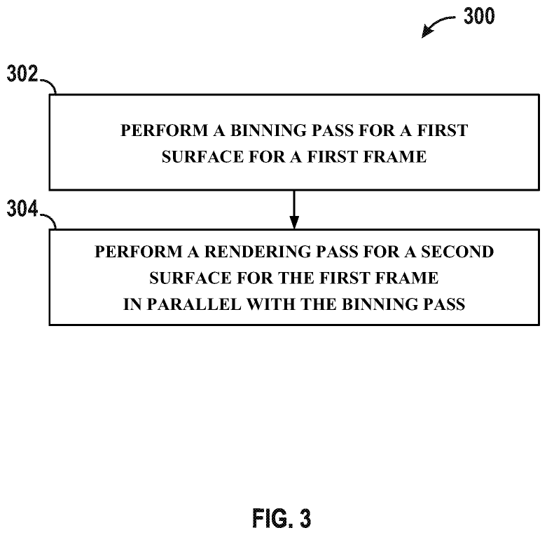

FIG. 3 illustrates an example flowchart 300 of a method in accordance with one or more techniques of this disclosure. The method may be performed by the second processing unit 106. In some examples, the method illustrated in flowchart 300 may include one or more functions described herein that are not illustrated in FIG. 3 and/or may exclude one or more illustrated functions.

At block 302, the second processing unit 106 may be configured to perform a binning pass for a first surface for a first frame. At block 304, the second processing unit 106 may be configured to perform a rendering pass for a second surface for the first frame in parallel with the binning pass.

The second processing unit 106 may be configured to perform a rendering pass for the second surface for the first frame, wherein the second surface is rendered based on second visibility information generated during a binning pass for the second surface. In some aspects, the first frame may include a plurality of surfaces, wherein each of the plurality of surfaces may be divided into a respective plurality of bins during the binning pass, wherein visibility information is generated for each of the respective plurality of bins The binning pass may be performed utilizing a first hardware pipeline of the second processing unit 106. The rendering pass for the second surface for the first frame may be configured to be performed concurrently with a binning pass of the first frame. The rendering pass may be performed utilizing a second hardware pipeline of the second processing unit 106. The binning pass of the first frame that can be performed concurrently with the rendering pass for the second surface for the first frame can be for a future surface. For example, a future surface that can be binned concurrently with the rendering of the second surface can be a third surface. In some aspects, the future surface can be a surface that is to be rendered after the second surface, such that the binning of the future surface can be performed concurrently with the second surface.

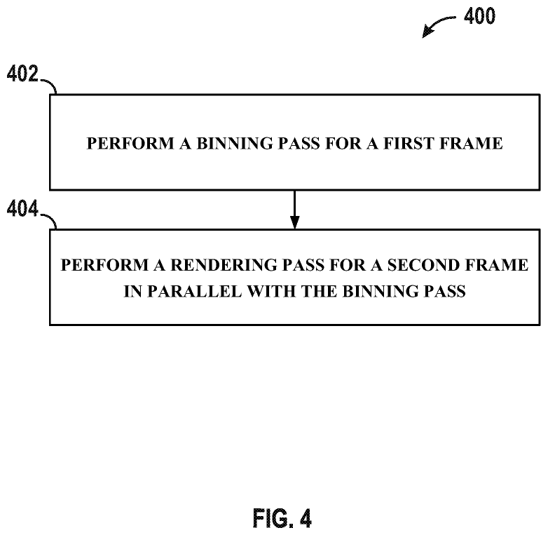

FIG. 4 illustrates an example flowchart 400 of a method in accordance with one or more techniques of this disclosure. The method may be performed by the second processing unit 106. In some examples, the method illustrated in flowchart 400 may include one or more function described herein that are not illustrated in FIG. 4, and/or may exclude one or more illustrated functions.

At block 402, the second processing unit 106 may be configured to perform a binning pass for a first frame. At block 404, the second processing unit 106 may be configured to perform a rendering pass for a second frame in parallel with the binning pass.

A binning pass can be performed on the first frame utilizing a first hardware pipeline of the second processing unit 106. The binning pass can be configured to divide the first frame into a first plurality of bins, wherein a first visibility information for a first bin of the first plurality of bins is generated. Once the binning pass for the first frame is completed, a rendering pass on the first frame may be performed. The rendering pass can be performed utilizing a second hardware pipeline of the second processing unit 106. Once the rendering pass for the first frame is completed, a binning pass for a second frame may be performed, wherein a second visibility information for a first bin of a second plurality of bins is generated. Once the binning pass for the second frame is completed, a rendering pass for the first bin of the second plurality of bins of the second frame is performed. However, while the rendering pass for the second frame is being performed, the second processing unit 106 may be configured to perform a binning pass in parallel with the rendering pass, such that the first bin of the second plurality of bins is rendered concurrently with the generation of the first visibility information for the first bin of the first plurality of bins.

**In some examples, the binning pass that can be performed concurrently with the rendering pass may be for one or more future frames yet to be rendered. In some aspects, a binning pass for a N frame may be performed concurrently with the rendering pass for at least a N−1 frame. For example, a binning pass for a third frame may be performed concurrently with the rendering pass for the second frame. In another example, the binning pass for the third frame may be performed concurrently with the rendering pass for the first frame. Binning passes do not take as much time and/or resources of the second processing unit 106 in comparison to rendering passes, such that the time to perform a binning pass for a particular frame is less than the time to perform a rendering pass for the particular frame. Furthermore, rendering passes do not utilize all the available resources of the second processing unit 106. As such, the second processing unit 106 may be configured to perform binning passes for one or more future frames concurrently while performing the rendering pass of a prior frame, which can reduce binning overhead. In some aspects, the binning pass for the third frame may be completed prior to the rendering pass of the second frame, such that a binning pass for a fourth frame may be performed concurrently with the rendering pass for the second frame. In such instances, once the rendering pass for the second frame is completed, a rendering pass for the third frame is commenced and may be performed concurrently with the binning pass of the fourth frame The binning pass for the third or other future frame may be performed during the rendering pass for the second frame because the binning pass does not utilize a majority of the second processing unit 106 resources in order to perform the binning pass.

In accordance with the techniques described herein, the second processing unit 106 may be configured to more efficiently generate graphical content for tile-based rendering. The second processing unit 106 may be configured to more efficiently perform the binning passes and the rendering passes for tile-based rendering. During a binning pass, the second processing unit 106 may not use all of the available resources of the second processing unit 106 to perform the binning pass. As such, the second processing unit 106 may not use its available resources efficiently, such that the second processing unit does not perform the binning pass optimally. During the binning pass, the second processing unit 106 runs through all the graphic commands in order to identify the potentially visible primitives, and screens out the non-visible primitives. In some aspects, a low-resolution depth buffer (e.g. an LRZ buffer) may be generated during a binning pass.

During the binning pass, only a small portion of the second processing unit 106 silicon is used, which means that most of the second processing unit 106 silicon is not used during the binning pass. This results in inefficient use of the second processing unit 106 and may be referred to as binning overhead (e.g., the cost to perform binning). In tile-based rendering, the second processing unit 106 performs the binning pass for a frame (e.g., a surface) before it performs a rendering pass for the frame. During the rendering pass, the second processing unit 106 may only render the primitives that were determined to be visible and/or potentially visible during the binning pass. In this way, the second processing unit 106 saves processing resources because primitives that are not visible are not rendered. A primitive may be non-visible for multiple reasons. For example, a primitive may be backward facing, or a primitive may be occluded by another primitive. In addition, during the rendering pass, the second processing unit 106 does not use all of the resources available to the second processing unit 106, such that the unused resources available during the rendering pass may be utilized to perform other processing.

The second processing unit 106 may be configured to reduce binning overhead, which can enable more dynamic operation of the second processing unit 106. For example, in accordance with the techniques described herein, the second processing unit 106 may be configured to perform a binning pass and a rendering pass concurrently, such that the binning pass and the rendering pass are performed in parallel. In some aspects, the second processing unit 106 may be configured to perform a rendering pass of a first surface during the binning pass of a second surface (e.g., a future surface). In some aspects, the second processing unit 106 may be configured to start a binning pass of a future surface during the rendering pass of a previously binned surface. The binning pass can be executed while the second processing unit 106 has available bandwidth. Since the binning pass workload is slight in comparison to the rendering pass workload, the binning pass will not significantly slow down the rendering pass. As a result, the binning pass and the rendering pass can be executed concurrently, or in parallel with each other. At least one advantage of concurrently performing a binning pass and a rendering pass is that the binning overhead can be reduced, which can also reduce the overall execution time for rendering a frame. For example, the second processing unit 106 may be configured to perform a rendering pass for a surface for a frame, wherein the surface is rendered based on visibility information generated during a binning pass for the surface. In some aspects, a frame may include a plurality of surfaces, wherein each of the plurality of surfaces may be divided into a respective plurality of bins during the binning pass. The rendering pass for the surface for the frame may be configured to be performed concurrently with a binning pass for the frame. The binning pass for the frame that can be performed concurrently with the rendering pass for the surface can be for a future surface. For example, a future surface that can be binned concurrently with the rendering of a first surface can be a second surface. In some aspects, the future surface can be a surface that is to be rendered after the first surface, such that the binning of the future surface can be performed concurrently with the first surface.

For example, in accordance with the techniques described herein, the second processing unit 106 may be configured to perform the binning pass using a first hardware pipeline, and the second processing unit 106 may be configured to perform the rendering pass using a second hardware pipeline. The second processing unit 106 may perform the binning pass and the rendering pass concurrently, such that the binning pass and the rendering pass are performed in parallel by way of the first and second hardware pipelines. In such an example, the second processing unit 106 may be configured to perform a binning pass for a first surface for a first frame. The second processing unit 106 may be further configured to perform a rendering pass for the first surface for the first frame in parallel with the binning pass for a second surface for the first frame.

During the binning pass for the first surface, the first surface may be divided into a first plurality of bins, such that the second processing unit 106 may be configured to generate first visibility information for the first plurality of bins of the first surface. In some aspects, the second processing unit 106 may be configured to generate first visibility information for each bin of the first plurality of bins of the first surface. The first visibility information generated during the binning pass is utilized by the second processing unit 106 to render the first surface during a rendering pass for the first surface for the first frame. During the rendering pass for the first surface, a binning pass for the second surface can start in the background. During the binning pass for the second surface, the second surface may be divided into a second plurality of bins, such that the second processing unit 106 may be configured to generate second visibility information for the second plurality of bins of the second surface. The generated second visibility information can be stored in an internal buffer until the rendering pass for the first surface is complete, at which point the second visibility information can be recalled from the internal buffer and the rendering pass for the second surface can commence.

During the rendering pass of the second surface for the first frame, the second processing unit 106 may be configured to render the second surface based on second visibility information generated during the binning pass for the second surface, which in some aspects the second visibility information can be generated in parallel with the rendering pass for the first surface. While the second processing unit 106 is performing the rendering pass for the second surface for the first frame, the second processing unit 106 can also generate visibility information for the plurality of bins of one or more future surfaces, such that the rendering pass and the binning pass are performed concurrently or in parallel.

The binning pass that can be performed concurrently or in parallel with the rendering pass may be a binning pass for a future surface, that has not yet been binned and rendered. In some aspects, a binning pass for a N surface may be performed concurrently with the rendering pass for at least a N−1 surface. For example, a binning pass for a third surface may be performed concurrently with the rendering pass for the second surface. In another example, the binning pass for the third surface may be performed concurrently with the rendering pass for the first surface. Binning passes do not take as much time and/or resources of the second processing unit 106 in comparison to rendering passes, such that the time to perform a binning pass for a particular surface is less than the time to perform a rendering pass for the particular surface. Furthermore, rendering passes do not utilize all the available resources of the second processing unit 106. As such, the second processing unit 106 may be configured to perform binning passes for one or more future surfaces concurrently while performing the rendering pass of a prior surface (e.g., a surface that has been binned), which can reduce binning overhead. In some aspects, the binning pass for the third surface may be completed prior to the rendering pass of the second surface, such that a binning pass for a fourth surface may be performed concurrently with the rendering pass for the second surface. In such instances, once the rendering pass for the second surface is completed, a rendering pass for the third surface is commenced and may be performed concurrently with the binning pass of the fourth surface. The binning pass for the third or other future surface may be performed during the rendering pass for the second surface because the binning pass does not utilize a majority of the second processing unit 106 resources in order to perform the binning pass.

FIG. 5 illustrates an example sequence 500 of a method in accordance with one or more techniques of the disclosure. The sequence 500 shows an example of multiple binning passes and rendering passes operating in parallel for a first frame 502-1 and a second frame 502-2. The frames can include a plurality of surfaces that may be blended together by the second processing unit 106 to generate a rendered frame. In the example of FIG. 5, the first frame 502-1 and the second frame 502-2 each includes three surfaces. For example, the first frame 502-1 includes a first surface S1, a second surface S2, and a third surface S3. The second frame 502-2 includes a first surface S4, a second surface S5, and a third surface S6. The first surface S1, second surface S2, and third surface S3 can each be binned, as discussed herein, wherein the binning passes generate respective visibility information for the surfaces S1-S3. The surfaces S1-S3 can each be rendered, as also discussed herein, wherein the rendering passes utilize the respective visibility information to render the surfaces S1-S3. The second processing unit 106 may be configured to combine (e.g., blend) the rendered surfaces S1-S3 together to generate the first frame 502-1. the first surface S4, second surface S5, and third surface S6 can each be binned and rendered, in a manner similar to the surfaces S1-S3, wherein the second processing unit 106 may be configured to combine (e.g., blend) the rendered surfaces S4-S6 together to generate the second frame 502-2. However, the frames can have any number of surfaces in other examples and is not intended to be limited to the example disclosed herein. FIG. 5 also shows which hardware pipeline each binning pass and each rendering pass may be performed on. The first hardware pipeline 504 is labeled as P1, while the second hardware pipeline 506 is labeled as P2. In the example of FIG. 5, each binning or rendering pass shown with respect to the first hardware pipeline P1 is understood as being performed by the first hardware pipeline P1, and each binning or rendering pass shown with respect to the second hardware pipeline P2 is understood as being performed by the second hardware pipeline P2. Each surface may be rendered into a respective buffer, which may be located in the internal memory 107 and/or the memory 110. The second processing unit 106 may be configured to combine (e.g., blend) rendered surfaces S1, S2, and S3 into a single frame, which may be stored into a framebuffer. In some examples, each respective buffer for each respective rendered surface may be referred to as an internal buffer or an intermediate buffer because it comes before the framebuffer.

As shown in FIG. 5, the second hardware pipeline P2 may be configured to perform a binning pass for the first surface S1 of the first frame 502-1 at 508-1. The first surface S1 is divided into a first plurality of bins during the binning pass. The second hardware pipeline P2 may be configured to generate first visibility information for the first plurality of bins for the first surface S1. Once the binning pass for the first surface S1 is completed, the second hardware pipeline P2 may be configured to perform a rendering pass for the first surface S1 at 510-1. During the rendering pass for the first surface S1, the second hardware pipeline P2 may be configured to render the first surface S1 based on the first visibility information generated during the binning pass for the first surface S1. The second hardware pipeline P2 may be configured to render the first surface S1 into a first intermediate buffer.

During the rendering pass for the first surface S1, the first hardware pipeline P1 may be configured to perform a binning pass for the second surface S2 of the first frame 502-1 at 512-1. In some examples, the binning pass for the second surface S2 may commence at the same time as the rendering pass for the first surface S1. In other examples, the binning pass for the second surface S2 may commence at a time after the rendering pass for the first surface S1 has commenced. The binning pass for the second surface S2 of the first frame 502-1 and the rendering pass for the first surface S1 of the first frame 502-1 are shown as being performed concurrently (i.e., in parallel). The binning pass for the second surface S2 may complete prior to the completion of the rendering pass for the first surface S1. During the binning pass for the second surface S2, the first hardware pipeline P1 may be configured to divide the second surface S2 into a second plurality of bins and generate second visibility information for the second plurality of bins for the second surface.

Once the binning pass for the second surface S2 is completed, the first hardware pipeline P1 may be configured to perform a binning pass for the third surface S3 of the first frame 502-1 at 516-1. In some examples, the binning pass for the third surface S3 may commence before the rendering pass for the second surface S2 begins. In other examples, the binning pass for the third surface S3 may commence at the same time as the rendering pass for the second surface S2 is commenced or at a time after the rendering pass for the second surface S2 has commenced. The binning pass for the third surface S3 of the first frame 502-1 is shown in the example of FIG. 5 as being performed concurrently with two different rendering passes: the rendering pass for the first surface S1 and the rendering pass for the second surface S2. For example, the binning pass for the third surface S3 is performed in parallel with a portion of the rendering pass for the first surface S1 and in parallel with a portion of the rendering pass for the second surface S2. During the binning pass for the third surface S3, the first hardware pipeline P1 may be configured to divide the third surface S3 into a third plurality of bins and generate third visibility information for the third plurality of bins for the third surface.

Once the rendering pass for the first surface S1 is completed, the second hardware pipeline P2 may be configured to perform a rendering pass for the second surface S2 at 514-1. During the rendering pass for the second surface S2, the second hardware pipeline P2 may be configured to render the second surface S2 based on the second visibility information generated during the binning pass for the second surface S2. The second hardware pipeline P2 may be configured to render the second surface S2 into a second intermediate buffer.

Upon the completion of the binning pass for the third surface S3 by the first hardware pipeline P1, the binning passes for all the surfaces of the first frame 502-1 have been completed. Once the rendering pass for the second surface S2 is completed, the second hardware pipeline P2 may be configured to perform a rendering pass for the third surface S3 at 518-1. During the rendering pass for the third surface S3, the second hardware pipeline P2 may be configured to render the third surface S3 based on the third visibility information generated during the binning pass for the third surface S3. The second hardware pipeline P2 may be configured to render the third surface S3 into a third intermediate buffer.

Once the binning pass for the third surface S3 is completed, the first hardware pipeline P1 may be configured to perform a binning pass for the first surface S4 of the second frame 502-2 at 508-2. In some examples, the binning pass for the first surface S4 of the second frame 502-2 may commence before at least one rendering pass associated with the first frame 502-1 has completed. For example, in the example of FIG. 5, the binning pass for the first surface S4 of the second frame 502-2 is shown as being performed concurrently with two different rendering passes: the rendering pass for the second surface S2 of the first frame 502-1 and the rendering pass for the third surface S3 of the first frame 502-1. For example, the binning pass for the first surface S4 of the second frame 502-2 is performed in parallel with a portion of the rendering pass for the second surface S2 of the first frame 502-1 and in parallel with a portion of the rendering pass for the third surface S3 of the first frame 502-1. During the binning pass for the first surface S4 of the second frame 502-2, the first hardware pipeline P1 may be configured to divide the first surface S4 into a first plurality of bins for the first surface and generate first visibility information for the first plurality of bins for the first surface S4 of the second frame 502-2.

A binning pass for a first surface S4 for the second frame 502-2 can be performed concurrently with the rendering pass for one of the surfaces for the first frame 502-1, at 508-2. In the example of FIG. 5, the binning pass for the first surface S4 for the second frame 502-2 may be performed during the rendering pass for the second surface S2 for the first frame 502-1 and during the rendering pass for the third surface S3 for the first frame 502-1. However, the start of the binning pass for the first surface S4 for the second frame 502-2 can occur at various times during other rendering passes and is not intended to be limited to the example disclosed herein. The start of binning passes for any of the surfaces can depend on many different factors, such that the start of a binning pass may vary for different surfaces. For example, a rendering pass for a particular surface may take longer or less time than other rendering passes which can cause the parallel binning passes to be performed during rendering passes of different surfaces. During the binning pass for the first surface S4 for the second frame 502-2, the first hardware pipeline P1 may be configured to divide the first surface S4 into a first plurality of bins and generate first visibility information for the first plurality of bins for the first surface S4. A binning pass for a second surface S5 for the second frame 502-2 can be performed at 512-2, such that the first hardware pipeline P1 is configured to divide the second surface S5 into a second plurality of bins and generate second visibility information for the second plurality of bins for the second surface S5.

Upon the completion of the rendering pass for the third surface S3 for the first frame, the second processing unit 106 may be configured to finalize the rendering of the first frame 502-1. In some examples, the second hardware pipeline P2, at 520-1, may be configured to combine (e.g., blend) the rendered first surface S1, the rendered second surface S2, and the rendered third surface S3 into the rendered first frame 502-1. The second processing unit 106 may be configured to output (e.g., store) the rendered first frame 502-1 into a framebuffer. Upon the finalization of the rendering of the first frame 502-1, a rendering pass for the first surface S4 for the second frame 502-2 can be performed at 510-2. In some examples, the rendering pass for the first surface S4 for the second frame 502-2 can start immediately after the finalization of the rendering of the first frame 502-1. In other examples, the rendering pass for the first surface S4 for the second frame 502-2 can start after a period of time after the finalization of the rendering of the first frame 502-1.

Upon the completion of the binning pass for the second surface S5 for the second frame 502-2, a binning pass for a third surface S6 for the second frame 502-2 can be performed at 516-2. The first hardware pipeline P1 is configured to divide the third surface S6 into a third plurality of bins and generate third visibility information for the third plurality of bins for the second surface S6. Upon completion of the rendering pass for the first surface S4 for the second frame 502-2, a rendering pass for the second surface S5 for the second frame 502-2 can be performed at 514-2. A rendering pass for the third surface S6 for the second frame 502-2 can be performed upon the completion of the rendering pass for the second surface S5 for the second frame at 518-2. After the rendering pass for the third surface S6 for the second frame 502-2 is completed, the second processing unit 106 can finalize the rendering of the second frame 502-2. The second hardware pipeline P2, at 520-2, may be configured to combine (e.g., blend) the rendered first surface S4, the rendered second surface S5, and the rendered third surface S6 into the rendered second frame 502-2. The second processing unit 106 may be configured to output (e.g., store) the rendered first frame 502-2 into a framebuffer.

In the example of FIG. 5, the binning pass for the third surface S6 for the second frame 502-2 may commence prior to the finalization of the rendering of the first frame 502-1, such that a substantial amount of visibility information for the second frame 502-2 has been generated prior to the finalization of the rendering of the first frame 502-1 and/or prior to any rendering passes for the second frame 502-2. As such, the second processing unit 106 reduces the binning overhead and utilizes its available resources more efficiently due, in part, to the binning pass and the rendering pass being performed concurrently or in parallel. At least one advantage of the disclosure is that the binning pass and the rendering pass being performed in parallel provides for the generation of visibility information of future surfaces, which enhances preparation and/or processing of the frames. In some examples, the binning pass and the rendering pass being performed concurrently could generate visibility information for surfaces well in advance of the rendering of a previous frame and/or surfaces. As shown in FIG. 5, substantially all of the surfaces of the second frame 502-2 can be binned and have generated respective visibility information prior to the rendering pass of the first surface S4 of the second frame 502-2.

In the example of FIG. 5, the first hardware pipeline (P1) 504 is configured to only perform binning passes, while the second hardware pipeline (P2) 506 is configured to perform binning passes and rendering passes. As denoted at 508-1, the second hardware pipeline performs the binning pass of the first surface S1 of the first frame 502-1 and performs the rendering passes, while the first hardware pipeline P1 performs the binning passes for the remaining surfaces (S2-S6). In some examples, the binning pass for the first surface S1 for the first frame 502-1 can be performed on the first hardware pipeline P1 instead of the second hardware pipeline P2. The first hardware pipeline P1 performing only the binning passes allows the binning passes to be performed concurrently or in parallel with the rendering passes on the second hardware pipeline P2, because the binning pass workload is much less in comparison to the rendering pass workload. Thus, by isolating binning passes and rendering passes, the second processing unit 106 can be configured to perform binning passes and rendering passes concurrently and efficiently utilizing the available resources. Therefore, the second processing unit 106 can perform efficient dynamic operations and reduce the overall execution time of the whole frame.

FIG. 6 illustrates an example hardware architecture 600 of the second processing unit 106. For example, the hardware architecture 600 includes a first hardware pipeline P1 and a second hardware pipeline P2. The first hardware pipeline P1 may correspond to the first hardware pipeline P1 referred to in FIG. 5. Similarly, the second hardware pipeline P2 may correspond to the second hardware pipeline P2 referred to in FIG. 5. The first hardware pipeline P1 may be configured to perform a binning pass, while the second hardware pipeline P2 may be configured to perform a rendering pass. In some examples, the first hardware pipeline P1 may be configured to only perform a binning pass, and the second hardware pipeline P2 may be configured to perform a rendering pass and/or a binning pass. In such examples, the first hardware pipeline P1 may be simpler (e.g., include less hardware) than the second hardware pipeline P2. In some examples, the first hardware pipeline P1 and second hardware pipeline P2 may be configured to share one or more common hardware components of the second processing unit 106. In such examples, the one or more common hardware components may include a shader processor configured to perform vertex shading, a vertex fetch decode (VFD) component, a triangle setup engine (TSE), a rasterizer unit (RAS), and/or other components.

The architecture 600 of the second processing unit 106 includes a command processor (CP) 602 that has a first output that is received by the first hardware pipeline P1 and a second output that is received by the second hardware pipeline P2. In the example of FIG. 6, the first hardware pipeline P1 includes a primitive controller (PC) 604, a vertex fetch decode unit (VFD) 606, a position cache (Pos $) 612, a second primitive controller (PC) 614, and a fixed function unit (FF) 616. The second hardware pipeline P2 may include many of the same or similar components as the first hardware pipeline P1. In the example of FIG. 6, the second hardware pipeline P2 includes a primitive controller (PC) 604′, a vertex fetch decode unit (VFD) 606′, a vertex patch cache (VPC) 612′, a second primitive controller (PC) 614′, and a fixed function unit (FF) 616′. The architecture 600 may further include a multiplexor (MUX) 608, a shader processor (SP) 610, a visibility stream compressor (VSC) 618, a unified cache (UCHE) 620, a graphic bus interface (GBIF) 622, and a system memory (MEM) 624. Some of the components of the first and second hardware pipeline P1, P2 can be the same and/or configured to perform similar operations. For example, the Pos $ 612 can be a simplified version of the VPC 612′, such that the Pos $ 612 performs the same operations as the VPC 612′ but only as needed for performing binning passes.

The CP 602 receives instructions from the second processing unit 106, such as a command stream from the driver. The second processing unit 106 may use the same command stream from the driver in an effort to minimize impact on the software. The command stream may be configured to include a set of instructions, one for the binning pass and another for the rendering pass. In some examples, when instructions for the binning pass are received, the CP 602 skips the rendering commands received in the set of instructions and only issues the binning commands to the first hardware pipeline P1. In some examples, when instructions for the rendering pass are received, the CP 602 skips the binning commands received in the set of instructions and only issues the rendering commands to the second hardware pipeline P2.

In examples where binning instructions are received by the CP 602, the CP 602 issues the binning commands to the first hardware pipeline P1. The first hardware pipeline P1 is dedicated to only perform the binning pass. The binning pass does not use as much resources of the second processing unit 106 in comparison to the resources used for the rendering pass. As such, the components of the first hardware pipeline P1 may be simplified versions of the corresponding components of the second hardware pipeline P2. The CP 602 sends the binning command to the PC 604, wherein the PC 604 instructs the VFD 606 to fetch the vertex data for the next surface/frame. The vertex data will then be sent to the shader processor 610. The shader processor 610 is configured to be shared with the first and second hardware pipelines P1, P2. However, prior to the shader processor 610 receiving the vertex data from the VFD 606, a multiplexor (MUX) 608 is configured to receive the output from the VFD 606 of the binning pass and the output from the VFD 606′ of the rendering pass and determines the availability of the SP 610 such that the data from the VFD 606 of the binning pass can be sent to the SP 610. The binning pass workload is much less in comparison to the rendering pass workload and the MUX 608 can determine the idle cycles of the SP 610 such that the SP 610 can receive the binning pass workload without significantly affecting the rendering pass workload. The SP 610 can perform vertex shading, and such results can be outputted to the Pos $ 612. The Pos $ 612 is substantially equivalent to the VPC 612′, and can be configured to be a simplified version of the VPC 612′. The Pos $ 612 only needs to calculate the position of the triangle and then uses the position of the triangle to determine if the triangle is visible within the display, whether the triangle is facing the viewer, or whether the triangle is hidden by other triangles. As such, a full VPC 612′ is not needed and a Pos $ 612 can instead be used. The PC 614 will take the output of the Pos $ 612 and creates primitives, and sends the primitives to the FF 616. The FF 616 creates the visibility information for the binning pass and is outputted to the VSC 618. The generated visibility information created during the binning pass can then be used during the rendering pass to render the binned surface.

In examples where rendering instructions are received by the CP 602, the CP 602 issues the rending commands to the second hardware pipeline P2. The instructions are sent to the PC 604′ which instructs the VFD 606′ to read vertex data from system memory 624. The VFD 606′ may be configured to retrieve vertex data from system memory 624 via the UCHE 620 and the GBIF 622. The GBIF is configured to receive the requests from all the clients and multiplexes them together and sends to the memory channel. The vertex data is then transported to the SP 610, wherein the SP 610 can perform vertex shading. The vertex shading results can include information directed to vertex number, vertex attribute, and vertex prediction. The vertex shading results are outputted from the SP 610 to the VPC 612′. The VPC 612′ may be configured to organize the vertex data, wherein the organized vertex data is then send to the PC 614′. The PC 614′ will take the organized vertex data and assembles the vertex into primitives, based on the vertex relationship. The PC 614′ will determine which vertex belong to which triangle, and based on the attributes puts the triangles together. The PC 614′ assembles the triangles using the shaded vertices. The assembled triangles are then sent to the FF 616′ which are then organized and stored in the FF 616′.

The FF 616′ takes the triangles from the PC 614′ and calculates the predictions and the view portions. The FF 616′ will check if triangles are within a display area, such that the triangle is visible. If the triangle is determined to not be within the display area, then the FF 616′ will drop the triangle, such that the triangle will not be drawn. The FF 616′ will also determine the direction triangles are facing, in order to determine if triangles are facing in a direction of a viewer and thus viewable. These computations are performed by the FF 616′ to determine if triangles are visible. The FF 616′ will do the triangle detection and visibility computations, and then the FF 616′ will break the triangle into pixels, which is the rasterization process, and detects which pixels are within the triangle. The FF 616′ also does the LRZ calculation, which determines the z value of the triangle to determine if the triangle is behind or in front of other triangles. Afterwards, the FF 616′ will determine if the primitive is visible within the display area, if not, then the primitive is marked as invisible. If the FF 616′ determines that the primitive is visible within the display area, then the primitive is marked as visible. The invisible and visible information will be sent to the VSC 618 by the FF 616′.

The VSC 618 takes the invisible and visible information from the FF 616′ for each triangle, and compresses the information and the VSC 618 sends the compressed information to the system memory 624. The FF 616′ can also output the compressed information to the UCHE 620. The UCHE 620 can be a storage unit or memory configured to be accessible by many clients, such as but not limited to the VSC 618, the FF 616′, and the SP 610. The UCHE 620 can have information read/write to it so that many different clients can access the stored information at a later time. The FF 616′ can also send the visible/invisible information to a fragment shader (not shown) within the FF 616′. The fragment shader is configured to generate the color for each pixel, and will send the color data back to the render backend and the color cache unit of the FF 616′, wherein the render backend of the FF 616′ does the blending and dithering and determines the final color data which is stored in the color cache unit. At the end of the rendering pass, the rendered surface could be one of many surfaces that can be used to form the finalized rendered surface. In some examples, each rendered surface could be a respective color buffer that can be utilized to form the final rendered surface.

In accordance with this disclosure, the term “or” may be interrupted as “and/or” where context does not dictate otherwise. Additionally, while phrases such as “one or more” or “at least one” or the like may have been used for some features disclosed herein but not others; the features for which such language was not used may be interpreted to have such a meaning implied where context does not dictate otherwise.

In one or more examples, the functions described herein may be implemented in hardware, software, firmware, or any combination thereof. For example, although the term “processing unit” has been used throughout this disclosure, it is understood that such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium. Computer-readable media may include computer data storage media or communication media including any medium that facilitates transfer of a computer program from one place to another. In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. By way of example, and not limitation, such computer-readable media can include RAM, ROM, EEPROM, CD-ROM or other optical disk storage, magnetic disk storage or other magnetic storage devices. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media. A computer program product may include a computer-readable medium.

The code may be executed by one or more processors, such as one or more digital signal processors (DSPs), general purpose microprocessors, application specific integrated circuits (ASICs), arithmetic logic units (ALUs), field programmable logic arrays (FPGAs), or other equivalent integrated or discrete logic circuitry. Accordingly, the term “processor,” as used herein may refer to any of the foregoing structure or any other structure suitable for implementation of the techniques described herein. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules or units are described in this disclosure to emphasize functional aspects of devices configured to perform the disclosed techniques, but do not necessarily require realization by different hardware units. Rather, as described above, various units may be combined in any hardware unit or provided by a collection of interoperative hardware units, including one or more processors as described above, in conjunction with suitable software and/or firmware.

Various examples have been described. These and other examples are within the scope of the following claims.

What is claimed is:

1. A method comprising:
performing, by a processing unit, a binning pass for a first surface for a first frame; and
performing, by the processing unit, a rendering pass for a second surface for the first frame in parallel with the binning pass.

2. The method of claim 1, wherein performing the binning pass comprises using a first hardware pipeline of the processing unit, and wherein performing the rendering pass comprises using a second hardware pipeline of the processing unit.

3. The method of claim 2, wherein the first hardware pipeline and the second hardware pipeline share a shader processor of the processing unit configured to perform vertex shading.

4. The method of claim 2, wherein the first hardware pipeline is configured to perform only binning and the second hardware pipeline is configured to perform both binning and rendering.

5. The method of claim 1, wherein performing the binning pass comprises:
dividing the first surface into a first plurality of bins; and
generating first visibility information for the first plurality of bins.

6. The method of claim 5, wherein performing the rendering pass comprises rendering the second surface based on second visibility information generated during a binning pass for the second surface, and wherein performing the rendering pass in parallel with the binning pass comprises:
rendering the second surface based on the second visibility information in parallel with generating first visibility information for the first plurality of bins.

7. A processing unit configured to:
perform a binning pass for a first surface for a first frame; and
perform a rendering pass for a second surface for the first frame in parallel with the binning pass.

8. The processing unit of claim 7, wherein to perform the binning pass, the processing unit is configured to use a first hardware pipeline of the processing unit, and wherein to perform the rendering pass, the processing unit is configured to use a second hardware pipeline of the processing unit.

9. The processing unit of claim 8, wherein the first hardware pipeline and the second hardware pipeline share a shader processor of the processing unit configured to perform vertex shading.

10. The processing unit of claim 8, wherein the first hardware pipeline is configured to perform only binning and the second hardware pipeline is configured to perform both binning and rendering.

11. The processing unit of claim 7, wherein to perform the binning pass, the processing unit is configured to:
divide the first surface into a first plurality of bins; and
generate first visibility information for the first plurality of bins.

12. The processing unit of claim 11, wherein to perform the rendering pass, the processing unit is configured to rendering the second surface based on second visibility information generated during a binning pass for the second surface, and wherein to perform the rendering pass in parallel with the binning pass, the processing unit is configured to:
render the second surface based on the second visibility information and generate first visibility information for the first plurality of bins in parallel.

13. The processing unit of claim 7, wherein the processing unit is a graphics processing unit.

14. The processing unit of claim 13, wherein the graphics processing unit is a component of a system on chip (SOC).

15. A method comprising:
performing, by a processing unit, a binning pass for a first frame; and
performing, by the processing unit, a rendering pass for a second frame in parallel with the binning pass.

16. The method of claim 15, wherein performing the binning pass comprises using a first hardware pipeline of the processing unit, and wherein performing the rendering pass comprises using a second hardware pipeline of the processing unit.

17. The method of claim 16, wherein the first hardware pipeline and the second hardware pipeline share a shader processor of the processing unit configured to perform vertex shading.

18. The method of claim 16, wherein the first hardware pipeline is configured to perform only binning and the second hardware pipeline is configured to perform both binning and rendering.

19. The method of claim 15, wherein performing the binning pass comprises:
dividing the first frame into a first plurality of bins; and
generating first visibility information for a first bin of the first plurality of bins.

20. The method of claim 19, wherein performing the rendering pass comprises:
rendering a first bin of a second plurality of bins of the second frame.

21. The method of claim 20, wherein performing the rendering pass in parallel with the binning pass comprises:
rendering the first bin of the second plurality of bins in parallel with generating the first visibility information for the first bin of the first plurality of bins.

22. The method of claim 20, wherein rendering the first bin of the second plurality of bins of the second frame comprises:
rendering the first bin of the second plurality of bins of the second frame based on visibility information associated with the first bin of the second plurality of bins.

23. A processing unit configured to:
perform a binning pass for a first frame; and
perform a rendering pass for a second frame in parallel with the binning pass.

24. The processing unit of claim 23, wherein to perform the binning pass, the processing unit is configured to use a first hardware pipeline of the processing unit, and wherein to perform the rendering pass, the processing unit is configured to use a second hardware pipeline of the processing unit.

25. The processing unit of claim 24, wherein the first hardware pipeline and the second hardware pipeline share a shader processor of the processing unit configured to perform vertex shading.

26. The processing unit of claim 24, wherein the first hardware pipeline is configured to perform only binning and the second hardware pipeline is configured to perform both binning and rendering.

27. The processing unit of claim 23, wherein to perform the binning pass, the processing unit is configured to:
divide the first frame into a first plurality of bins; and
generate first visibility information for a first bin of the first plurality of bins.

28. The processing unit of claim 27, wherein to perform the rendering pass, the processing unit is configured to:
render a first bin of a second plurality of bins of the second frame.

29. The processing unit of claim 28, wherein to perform the rendering pass in parallel with the binning pass, the processing unit is configured to:
render the first bin of the second plurality of bins and generate the first visibility information for the first bin of the first plurality of bins in parallel.

30. The processing unit of claim 28, wherein to render the first bin of the second plurality of bins of the second frame, the processing unit is configured to:
render the first bin of the second plurality of bins of the second frame based on visibility information associated with the first bin of the second plurality of bins.
